(19) United States
(12) Patent Application Publication
(10) Pub. No.: US 2009/0019289 A1
(43) Pub. Date: Jan. 15, 2009

(54) NEGATIVE AUTHENTICATION SYSTEM FOR A NETWORKED COMPUTER SYSTEM

(75) Inventor: Dipankar Dasgupta, Germantown, TN (US)

Correspondence Address: BUTLER, SNOW, O'MARA, STEVENS & CANNADA PLLC, 6075 POPLAR AVENUE, SUITE 500, MEMPHIS, TN, 38119, US

(73) Assignee: University of Memphis Research Foundation, Memphis, TN (US)

(21) Appl. No.: 12/171,962

(22) Filed: Jul. 11, 2008

Related U.S. Application Data
(60) Provisional application No. 60/959,551, filed on Jul. 13, 2007.

(51) Int. Cl. H04L 9/00

(52) U.S. Cl. 713/183

(57) ABSTRACT

The disclosed invention is a method for screening access to a computer system using a negative authentication system. Input login requests are compared against a set of detectors comprising anti-passwords and only allowed further access if they do not match any of the anti-passwords. A method of generating a set of detectors comprising anti-passwords is also disclosed.

### CROSS REFERENCE TO RELATED APPLICATIONS

This application claims the benefit of U.S. Provisional Application No. 60/959,551, filed Jul. 13, 2007.

### BACKGROUND OF THE INVENTION

Increased use of the internet for commercial purposes has brought an increased concern over how to protect the important confidential data and private financial information that passes over the network. The Department of Homeland Security has indicated that, although globalization of the world's technology industry will provide more opportunities, it also creates new security challenges, as does the move to a single, integrated Internet protocol. There is a trade off between efficiency gains and cost savings, and the heightened level of vulnerability in our networks. Every company knows the importance as well as the difficulty of protecting its critical information, as security vulnerabilities exist both inside and outside of its network.

Most security breaches occur through unauthorized access. Passwords are the key to the kingdom—the enterprise network. However, the protection of passwords is a real challenge for any authentication system. Cyber vulnerabilities reported to the U.S. CERT (Computer Emergency Readiness Team) increased from 171 incidents in 1995 and 345 incidents reported in 1996 to 5,990 incidents in 205, 8,064 incidents in 2006, and 7,236 incidents in 2007. See CERT website at www.cert.org/stats/fullstats.html.

One of the key challenges in computer security research is to develop strong methods of authentication, i.e., to determine whether a user should be allowed access to a given system or resource. In many cases, lack of proper authentication results in hacking. The need for password protection is ever increasing as the hackers are finding new ways to crack password security systems and break-in and steal sensitive (proprietary, personal) information.

Many factors that make passwords cracking possible. These include human factors such as short or easily-guessed passwords, as well as usage of weak (proprietary) algorithms, export restrictions that prohibit usage of strong cryptography, incorrect usage of strong algorithms, and implementation flaws including backdoors, and bugs.

Common password cracking techniques include Brute force attacks, Dictionary attacks, and Hybrid attacks. A combination of two or more of these attacks is known as a “syllable attack.” Syllable attacks may be used when a password is deformed or a non-existing word is used, and the cracker can combine the syllables to get such a word. The most powerful attack type is a “rule-based attack,” which a cracker can use when he obtains some information about the password that he wants to crack. For example, if he knows a password consists of a word and a one- or two-digit number, he writes that rule and the program generates only suitable passwords (user1, mind67, snapshot99 etc). Finally, some weak algorithms allow a “known-plaintext attack” if a cracker has some files or files fragments in un-encrypted form and wants to decrypt others. Strong crypto-algorithms successfully resist this type of attack—the knowledge of an unencrypted file will give nothing to the cracker.

Password cracking tools become a major security threat as they allow hackers to gain access to the system and perform harmful activities. These tools can decrypt passwords or otherwise disable password protection (e.g. decrypt a file without knowing the password). If the mechanisms of password protection use weak encryption, then it is possible to recover the original password or pick a new one, considered to be correct. Examples of some password cracking tools that are available include JOHN THE RIPPER, THC HYDRA, RAINBOW CRACK, BRUTUS, L0PHTCRACK, etc.

Many approaches are being developed for what is known as “positive identification” (PI) of a legitimate user. These include the use of strong static passwords, one-time passwords, and dynamic passwords and pass phrases. (A pass phrase is similar to a password in usage, but is long, such as a sequence of words or other text, for added security.) Many other mechanisms have also been developed to improve authentication systems, including personal identification numbers (PIN), security tokens (or sometimes hardware, cryptographic, authentication or other tokens), password managers, single sign-on systems (SSO), challenge handshake authentication protocol systems (CHAP), callbacks, and graphical passwords. Market products which provide similar systems include ENTRUST IDENTITY GUARD, PASSTRIX, CURION'S NETPROTECT PASSWORD MANAGER, ETOKEN, and CITRIX PASSWORD MANAGER.

All the existing approaches designed for secure authentication, including those listed above, use a positive identification database during their authentication processes. However, this method is dangerous. The password information table could be read or altered by an intruder. An intruder can also append a new ID and password into the table. Lack of proper authentication gives way to easy hacking. Once hackers gain access to a system, they can perform harmful activities including launching distributed denial of service attacks, defacing web sites, stealing billing and credit card information, making fraudulent purchases, and stealing confidential information. In fact, most security penetration occurs when the security validation information is exposed in some way. In short, there is a need for a password authentication system that avoids the shortcomings of a positive identification system.

In typical positive identification systems currently being used, each user password is stored in the system, on a password server, in a cryptographic form, called Hash function. Hashing converts a string of any length at the input into a bit-string of fixed length, or hash, at the output. It has two main characteristics—even a minor modification in the input string changes the output hash value; and it is practically impossible to find the input string knowing the hash value, i.e. it is irreversible. These traits, however, do not prevent attackers from entering multiple variations of a potential password, with the expectation that at some point the right combination will be chosen. Thus the existing use of positive identification data directly during authentication process makes systems vulnerable to attacks.

The invention claimed herein is a new non-obvious system and method for user authentication utilizing an immunity-based approach to build a password immunization system. This system improves the security of authentication mechanisms by uniquely examining the validity of users in order to prevent unauthorized access to sensitive information.

### BRIEF SUMMARY OF THE INVENTION

This invention provides a robust solution to the problem of preventing unauthorized access to a computer system of one or more computers by immunizing authentication systems, be they local, remote, or online. It does this by adding a layer of password protection which is invisible to the user. Detectors are created to cover the space of possible but invalid passwords, the space known as “Anti-P,” but the set of detectors should not include any valid or correct passwords which would be passwords validly assigned to a user of the system. These detectors may be referred to as “anti-passwords.” Ideally, the set of detectors covers the “Anti-P” space.

In a preferred embodiment, every access request includes the steps of accepting a login request, encrypting the login request to create an encrypted login request, comparing the encrypted login request to a set of detectors, and rejecting access to the computer system if the encrypted login request matches any element of the set of detectors. Only if the access request is not rejected does it pass on to be checked for positive password authentication.

The access request can be a username and password or any other positive identification input, such as a PIN, biometric information, signature capture information, or any other type of input a user may use to access a computer system. If the access request is a username and password, the initial encrypting of the login can include the step of MD5 hashing the password, combining the hashed password with the username to create a partially encrypted entry, and MD5 hashing the partially encrypted entry to create a fully encrypted entry. In a preferred embodiment, the fully encrypted entry can be further parsed into an n-dimensional format decimal and then mapped to a real valued-representation to create segments with a predefined number of variables and then normalized to be within the range [0.0, 1.0].

The set of detectors for a negative authentication system may be generated in many ways, but one preferred embodiment includes the steps of storing a set of valid login entries, encrypting the valid entries to create a set of encrypted valid login entries, identifying the possible password space, and evolving a set of detectors by iteratively applying either a deterministic or stochastic process or a combination thereof until a set is created covering the possible password space minus the set of encrypted valid login entries, i.e. the anti-password space or unused password space.

The disclosed system is a unique multi-layered system which acts as a shield to the positive authentication system. This negative authentication system first checks for negative authentication before any positive verification during the login process. Even if the anti-passwords are compromised, deriving any individual password by someone with ill intent is not possible. Variable-sized anti-passwords generated through the evolutionary process provide better coverage and protection. By using this robust negative authentication system before allowing for positive password authentication, the use of automated password cracking tools will be less effective. This increased security means that the use of a distributed negative authentication system will allow secure access to resources from anywhere on the Internet. As an add on to the system, it will be possible to further analyze the invalid access attempts after a false password is linked up with one of the matched anti-passwords the system has generated.

### BRIEF DESCRIPTION OF THE SEVERAL VIEWS OF THE DRAWINGS

FIG. 1 illustrates steps in a standard positive authentication process.

FIG. 2 illustrates steps in a multi-layered authentication process incorporating a negative authentication process.

FIG. 3 illustrates a process for generating a set of Anti-P detectors.

FIG. 4 illustrates the negative authentication process.

FIG. 5 shows the different phases of the encryption process for input login entries in the form of a username and password.

FIG. 6 is a flow chart illustrating the generation of detectors (Anti-P's) and validation against Anti-P's

FIG.7 shows RNS pseudo-code for Anti-P generation.

FIG. 8 illustrates for an alternate method of Anti-P generation the computational steps used during the detector maturation process.

FIG. 9 is a flow diagram showing the steps of the variable-size detector generation.

### DETAILED DESCRIPTION OF THE INVENTION

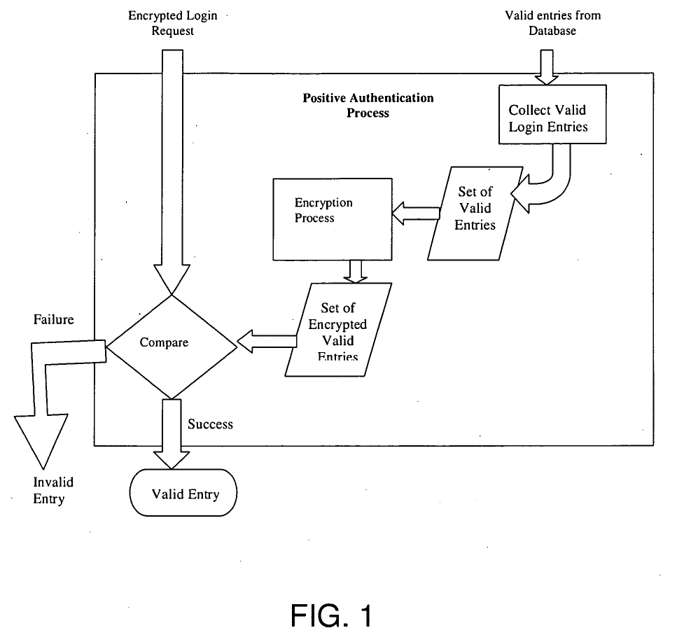

The claimed Negative Password Immunizer System uses a novel and non-obvious approach of creating a “Negative Authentication” system to improve authentication and authorization systems. Most authentication systems use password data (user id/self-space) to identity legitimate users, which is referred to as Positive Identification (PI). These systems typically use a password profile (positive identification database) containing all the user passwords who are authorized to access the system or a secure server. FIG. 1 illustrates the steps in the standard positive authentication process.

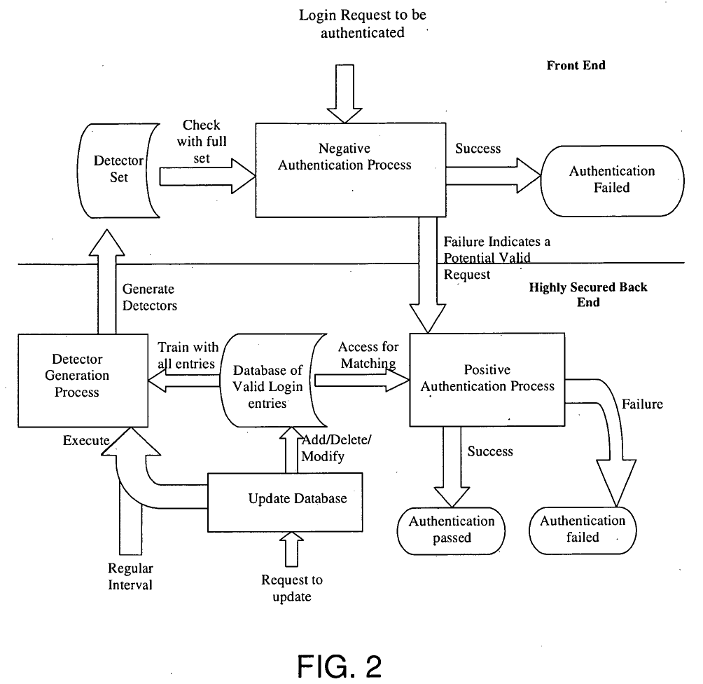

The new concept described herein uses the negative counterpart of the PI user space by creating an “Anti-password space” (non-self) which contains all feasible strings that are not in the password database, but can be used for password guessing or cracking. Once this anti-password space has been created, the passwords submitted in all attempts to log on to the system are first compared to the anti-passwords (Anti-P) that have been generated, and if the submitted password matches any found in the Anti-P space, the request to log on is denied. If the submitted password does not match any found in the Anti-P space, the submitted password is passed on to the PI database for match, authentication and completion of the log in process. While the anti-password space appears to be very large, our technique uses a form of implicit clustering to generate a few Anti-P detectors to cover this attack (non-self) space. FIG. 2 illustrates the steps involved in login for a computer utilizing a multi-layered authentication process incorporating the negative authentication process.

The major advantage of this approach is that it is hard (if not impossible) to discover an individual password even if Anti-P detectors are compromised. A unique advantage of the claimed system is that it tries to filter out illegitimate users (hackers, crackers, etc.) before allowing legal users to access the positive password verification system. As hackers find new ways to break positive password authentication systems because of weaknesses in their various components, this non-obvious additional layer of protection is very useful because it shields the positive password authentication system from at least some unauthorized access. This system provides the robust solution of immunizing any authentication system (local, remote or online) by adding a layer of protection, invisible to the user. The new approach claimed herein first checks the entered string against the Negative Password Immunizer System (negative authentication) before any positive verification during the logon process.

Central to the Negative Password Immunizer System described herein is the Negative Selection Algorithm (NSA). The negative selection algorithm can be summarized as follows:
1. Define permissible passwords as a collection P of elements in the password space U, a collection that needs to be protected. For instance, if U corresponds to the password space (represented by encrypted alphabets and determined by crypto/hash being used), P can represent the subset of passwords that are validly assigned to users of the system.
2. Generate a set “Anti-P” of detectors, each of which fails to match any string in P. One approach that works to generate random detectors and discard those that match any element in the “self” set (P). However, a more efficient approach tries to minimize the number of generated detectors while maximizing the covering of the “non-self” space.
3. Check every login request against the Anti-P detectors. If any detector matches, then it indicates that the entered password is not correct, as the Anti-P detectors are designed not to match any representative of P.

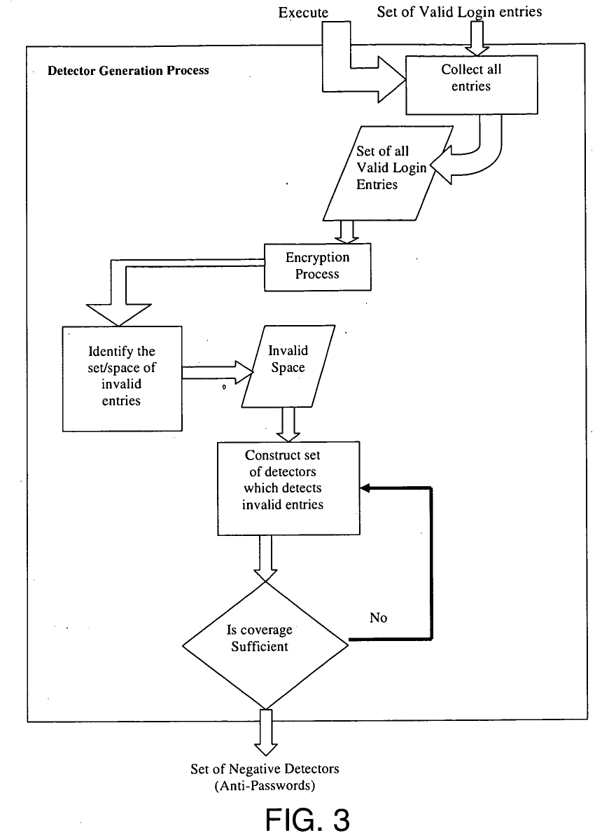

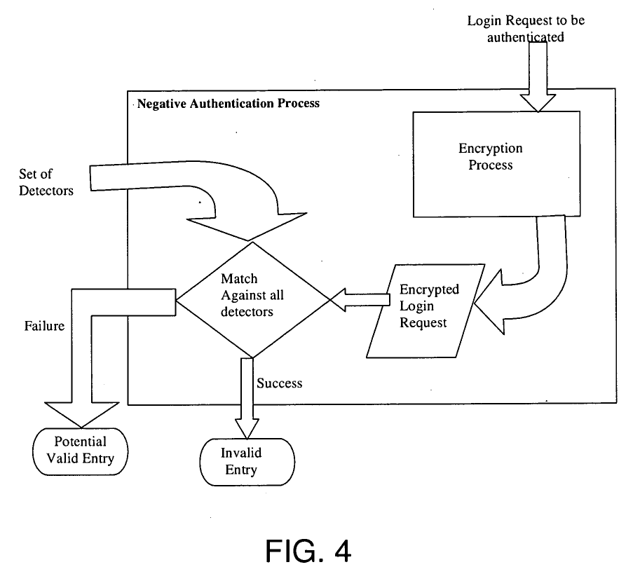

FIG. 3 shows a method for generating a set of Anti-P detectors. Anti-Ps are generated in the highly secured area which is then circulated in the Anti-P system as a part of negative authentication. FIG. 4 shows use of the detectors in a negative authentication system.

From the foregoing, it is clear that the algorithmic complexity of generating good detectors can vary significantly, which depends on the Anti-P detector representation scheme, and the rule that determines if an Anti-P detector matches a user entry. One preferred embodiment of the instant system is described as follows:

Phase 1: Passwords File (Data Collection):

Each entry in the generated file represents an account detail and is of the format Username and hash value of the password which are separated using “:” as the separator.

Phase 2: Preprocessing:

Step 1: Each entry in the password file is rehashed using the MD5 encryption method. The password file is transformed into the hash values of the “Username and hash value of the password” which is a 32-bit hexadecimal format.

Step 2: This file is parsed to 4-dimensional formats which are converted to decimal representation. Next the data is normalized where actual values of the variables are scaled to fit in the defined range of [0.0, 1.0] using maximum and minimum (±20% to normal data) value of each dimension in the data set. Any value above or below the defined max or min is set to 1.0 or 0.0, respectively.

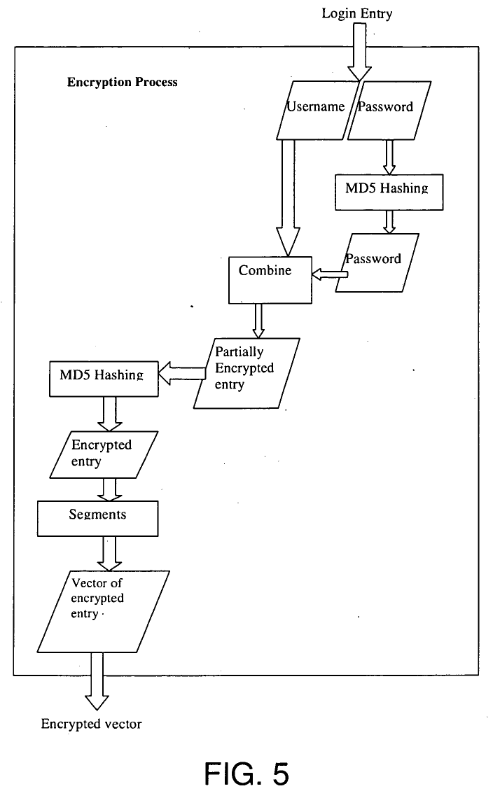

FIG. 5 is a flow chart showing the steps of encrypting the entered login entry if the login entry is in the format of a username and password.

Phase 3: Anti-P Generation:

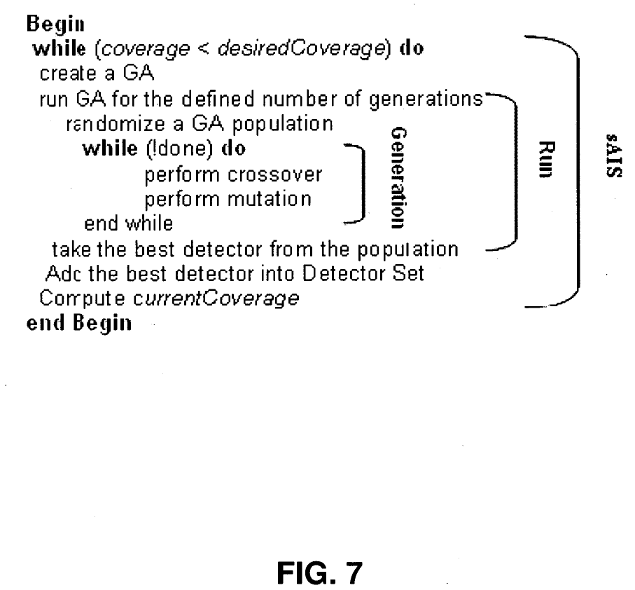

Most of the research works on the NSA have been restricted to binary matching rules like r-contiguous. These rules are simple to use, and there exist efficient algorithms to generate detectors, exploiting the simplicity of the binary representation and its matching rules. However, the scalability issue has prevented it from being applied more extensively. In a preferred embodiment, the inventors developed several versions of real-valued negative selection algorithms (NSA) to generate Anti-Passwords. Each algorithm uses only one class (password) for generating Anti-Passwords for the complement class (Anti-Ps). The work applies an evolutionary approach called niching GA to generate Anti-P detectors from the given password profile (database). The goal of niching GA is to evolve a set of Anti-Ps to cover the non-self space. The iterative process in FIG. 7 is one method to generate a set of Anti-Ps driven by two main goals:
1. Should not overlap with positive passwords (PIs), and
2. Make the Anti-P's as large as possible and keep them separate from each other, in order to maximize the non-self covering.

The niching GA runs multiple times to generate different Anti-Ps to cover the entire non-self region. Each run involves the generation of a new Anti-Ps, covering a portion of the non-self region while modifying its raw fitness as per the overlap with the previously selected Anti-Ps. Considering the Password data, which is random, the detectors are generated randomly to meet the criteria of total non-self space coverage and no self overlap. As the password file size increases, the detectors are generated with smaller shapes to satisfy the coverage requirements. For the process of generating the Anti-P space, the complete PI set is used. The generation process of Anti-P's makes sure that none of the self elements (i.e. valid credentials) are covered by Anti-P's, hence never will be the case that a valid user be filtered by the Anti-P system. Therefore the False Alarm Rate is always 0.

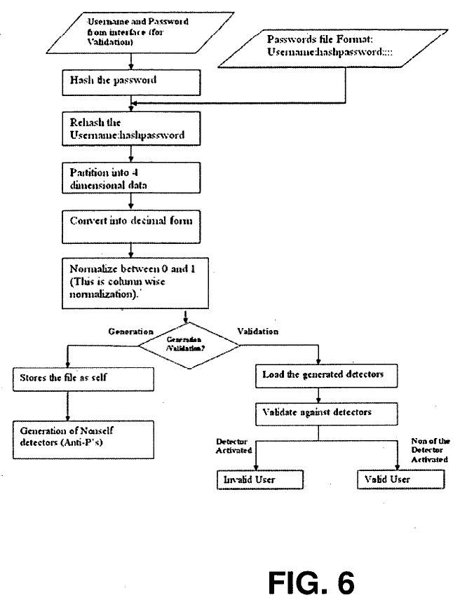

The generation process accepts a complete password file and processes the file into the 4-dimensional data which is normalized between 0 and 1. This self file is stored and used for the generation of Anti-Ps. The validation process accepts a single user name and password from the user interface and preprocesses it for checking against the generated Anti-Ps. FIG. 6 shows a flow chart for one method of generation of detectors (Anti-P's) and validation against Anti-P's. FIG. 7 shows the RNS pseudo-code for one method of Anti-P generation.

Different real-valued algorithms are also possible to generate anti-password detectors for negative authentication system, including the following alternative to Phase 3:

Phase 3 (Option 2): An Iterative Approach in Generating Negative Detectors

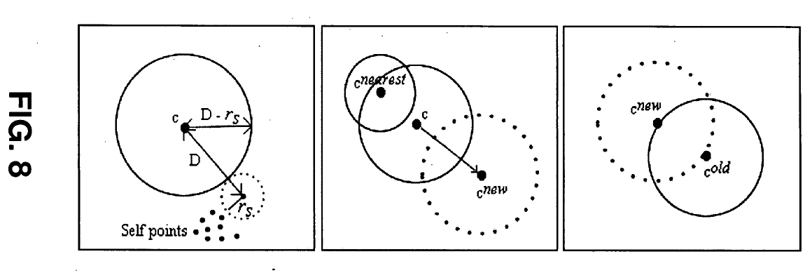

In this approach, an initial population of candidate detectors is generated at random. Such detectors then mature through an iterative process. In each iteration, the radius of each detector is calculated as r_{d}=D−rₛ, where rₛ is the variability around a self point. FIG. 8 illustrates the computational steps used during the detector maturation process. Diagram (a) shows a way to calculate and update the radius of a detector. Diagram (b) shows that if a candidate detector overlaps with an existing detector (or self points), then the candidate detector (i.e. its center, c) is moved in the opposite direction to its nearest neighbor detector. Diagram (c) illustrates the concept that given a mature detector, a clone is created at a distance equal to its radius, and the direction where it is created is selected at random.

During an iterative process, detectors are moved away from self input data and the other existing detectors. During this process, the detectors are ranked according to their coverage. The larger detectors are considered better fit and selected to go to next generation. The smaller detectors are discarded and replaced with clones of the better-fit detectors. A clone of a detector is generated by moving center of the original detector by a fixed distance to its proximity. In addition, new random detectors are introduced to explore new area of the non-self space. The detector generation process terminates when a set of mature detectors are evolved that can provide significant coverage of non-self coverage.

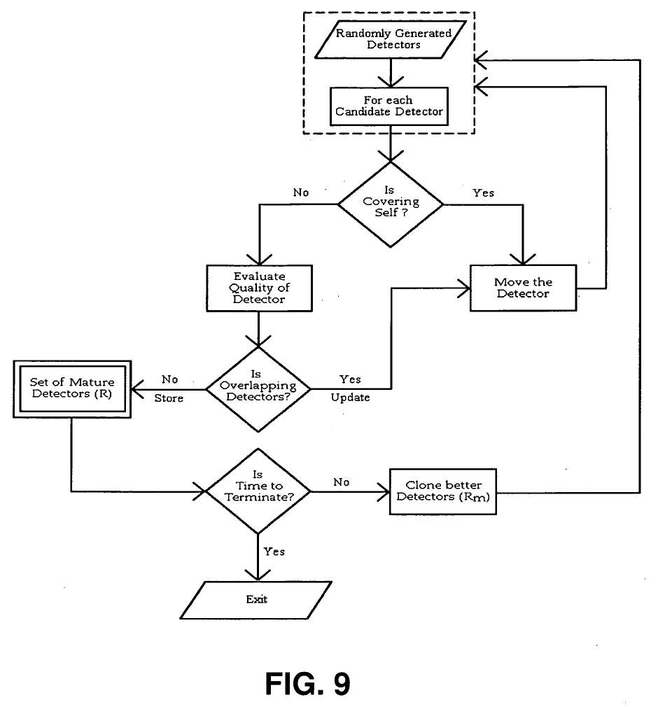

FIG. 9 shows the flow diagram of the iterative approach of generating variable-size negative detectors.

While the methods disclosed herein are a good way to practice the invention, one having ordinary skill in the art would understand that other methods of generating the set of detectors or encrypting login requests are possible. The embodiments described herein are in no way intended to limit the claims to the embodiments described.

We claim:

1. A method for screening access to a computer system comprising the steps of:
a) accepting a login request;
b) encrypting the login request to create an encrypted login request;
c) comparing the encrypted login request to a set of detectors; and
d) rejecting access to the computer system if the encrypted login request matches any element of the set of detectors.

2. The method of claim 1 further comprising the step of performing standard positive password authentication on the login request if access is not rejected.

3. The method of claim 1 wherein the login request comprises a username and password.

4. The method of claim 1 wherein the login request comprises a form of positive identification login request not comprising a username and password.

5. The method of claim 1 wherein the step of encrypting the login request to create an encrypted login request comprises the steps of:
a) MD5 hashing the password;
b) combining the hashed password with the username to create a partially encrypted entry; and
c) MD5 hashing the partially encrypted entry to create a fully encrypted entry.

6. The method of claim 4 wherein the step of encrypting the login request to create an encrypted login request further comprises the steps of:
a) parsing the fully encrypted entry into an n-dimensional format to create an n-dimensional representation;
b) mapping the n-dimensional representation to a real-valued representation to create segments comprising a predetermined number of variables; and
c) normalizing the variables to be within the range [0.0,1.0].

7. The method of claim 1 wherein the set of detectors comprise anti-passwords.

8. The method of claim 1 wherein the set of detectors does not include any correct passwords.

9. The method of claim 1 wherein the set of detectors fully covers the set of incorrect but possible passwords.

10. The method of claim 1 wherein the computer system is comprised of a plurality of at least one computer.

11. The method of claim 1 wherein the computer system is comprised of a plurality of at least two computers.

12. The method of claim 1 wherein the computer system is comprised of a plurality of computers connected by a computer network.

13. The method of claim 1 wherein the computer system is comprised of a plurality of computers connected by the internet.

14. A method for generating a set of detectors for a negative authentication system comprising the steps of:
a) storing a set of valid login entries;
b) encrypting the valid login entries to create a set of encrypted valid login entries;
c) identifying the possible password space; and
d) evolving a set of detectors by iteratively applying a process, selected from a list consisting of a deterministic process, a stochastic process, and a combination of deterministic and stochastic processes, until a set is created covering a space of invalid but possible passwords.
